(19) United States
(12) Patent Application Publication
(10) Pub. No.: US 2003/0001877 A1
(43) Pub. Date: Jan. 2, 2003

(54) Device for converting a BIFS text format into a BIFS binary format

(76) Inventor: Laurent Michel Olivier Duquesnois, Caen (FR)

Correspondence Address: U.S. Philips Corporation, 580 White Plains Road, Tarrytown, NY, 10591, US

(21) Appl. No.: 10/128,639

(22) Filed: Apr. 23, 2002

(30) Foreign Application Priority Data
Apr. 24, 2001 (FR) 0105503

(51) Int. Cl. G09G 5/00

(52) U.S. Cl. 345/716

(57) ABSTRACT

The invention relates to the field of describing multimedia scenes. A data stream in the BIFS format 121 comprises, in conventional manner, two types of data, descriptions of the scenes 122 and commands 123. According to the invention, a data-processing device intended to convert data from a first format, for example, the BIFS text format, into a second format, for example, the BIFS binary format, comprises a scene transcoder 101 intended to convert the descriptions of the scenes 122 from the first format into the second format, and a command transcoder 111 intended to convert the commands 123 from the first format into the second format and having access to information comprised in the scene description. The invention is particularly interesting for conceiving descriptions of multimedia scenes using, for example, the MPEG4 standard.

### FIELD OF THE INVENTION

The invention relates to a data-processing device for converting data from a first format into a second format, said data comprising at least a scene description and a command intended to modify said scene description.

The invention also relates to a data-processing method of converting data from a first format into a second format, said data comprising at least a scene description and a command intended to modify said scene description.

The invention also relates to a program comprising program code instructions for performing the steps of this method when said program is executed on a processor.

The invention is used in, for example, a system intended to conceive audiovisual data in an MPEG format.

### BACKGROUND OF THE INVENTION

The MPEG4 standard is notably described in the document ISO/IEC 14496-1, entitled “Information Technology—Very Low Bit Rate Audiovisual Coding—part 1: Systems” published by ISO in 1999. This standard particularly describes a binary scene format BIFS having for its object to describe spatiotemporal relations between various graphic objects of a scene. Information which is necessary for composing a scene constitutes a scene description. A concept of a scene description is given in section 9 of this standard. A scene description has a tree structure composed of nodes, each node corresponding to an object and comprising a set of fields. Routes are used to assign the value of one field to another field. A data stream in BIFS format comprises two types of data, scene descriptions and commands. The commands may be of two types:

commands for replacing the scene, comprising a whole scene description,

commands for modifying the scene, comprising modifications to be applied to a scene description, like a replacement of one node by another, an addition or a suppression of a node, a modification of a field or of a route.

A scene description is generally written by an author by using a user-friendly format, for example, a text format. The commands are generally written in the same format. This format will hereinafter be referred to as BIFS text format. However, for a transport of a data stream in the BIFS format, it is necessary to convert the BIFS text format into a binary format, which will hereinafter be referred to as BIFS binary format. Such a conversion allows simultaneous transportation of a very large quantity of information. The BIFS binary format as well as the conversion from the BIFS text format into the BIFS binary format has been described in the above-cited standard. This standard describes how the scene descriptions must be converted and how the commands must be converted from the BIFS text format into the BIFS binary format. However, the above-cited standard does not describe any device for converting the BIFS text format into the BIFS binary format.

### OBJECT AND SUMMARY OF THE INVENTION

It is an object of the invention to provide a device with which a BIFS text format can be converted into a BIFS binary format.

According to the invention, a data-processing device as defined in the opening paragraph is characterized in that it comprises:

a scene transcoder for converting the scene description from the first format into the second format, and

a command transcoder for converting the command from the first format into the second format and having access to information comprised in the scene transcoder.

According to the invention, a data-processing method as defined in the opening paragraph is characterized in that it comprises the steps of:

transcoding the scene for converting the scene description from the first format into the second format, and

transcoding commands for converting the command from the first format into the second format by means of information elaborated during the scene transcoding step.

According to the invention, a BIFS text data stream is converted into a BIFS binary data stream in the following manner. The data relating to the scene description are converted by the scene transcoder as described in the above-cited standard, and the data relating to the commands are separately converted by the command transcoder as described in the above-cited standard. However, to be able to convert the data relating to the commands, the command transcoder must have access to information which is present in the scene transcoder, such as names and identifiers of nodes. Indeed, each node of the scene description has a name and an identifier. The name is a text which allows identification of a node in a user-friendly manner. The identifier is a number which indicates a location of a node in the scene description. Only the identifier of a node is converted into the BIFS binary format. The commands in the BIFS text format only comprise the names of the nodes. Consequently, the command transcoder needs a table of correspondence between the names and the identifiers of the nodes, which table is comprised in the scene transcoder. Consequently, when a command modifies the scene description, it is not necessary to again convert the whole scene description from the BIFS text format into the BIFS binary format, but only the command. The conversion is thus more rapid, which may be advantageous in applications that are subject to real-time constraints.

In a particularly advantageous embodiment of the invention, a data-processing device as described above is characterized in that it comprises:

a graphic interface;

a compositor suitable for supplying an audiovisual representation of the scene description on the graphic interface;

modification means connected to said graphic interface and being suitable for effecting at least a modification of said audiovisual representation, and

editing means suitable for generating at least a command in the first format, said command being representative of the modification.

This embodiment allows an author to modify a scene description in a user-friendly manner. Indeed, by virtue of the compositor and the graphic interface, the author has at any instant an audiovisual representation of the scene description which he wishes to modify. Using a mouse, a keyboard or any other modification means connected to the graphic interface, he modifies this audiovisual representation as he wishes. Editing means allow commands in the BIFS text format to be generated on the basis of the modifications effected by the author. Such editing means are known to those skilled in the art by the term of authoring tool. Moreover, this embodiment allows use of dynamic commands, i.e. commands generating a modification of the scene description which does not take immediate effect, while conserving its user-friendly aspect. For example, it is possible to carry out a command intended to generate the modification of a node at a given future instant. When one is satisfied with converting the scene description into the BIFS binary format at the instant when the command is carried out, this command would not be taken into account because the modification would only take effect at a future instant.

In so far as the steps described above can be performed by means of software, the invention also provides a program comprising program code instructions for performing the steps of the method described above when said program is executed on a processor.

### BRIEF DESCRIPTION OF THE DRAWINGS

FIG. 1 is a block diagram illustrating characteristic features of the invention;

FIGS. 2a and 2b illustrate two examples of data-processing devices of the prior art, allowing conversion of data from a first format into a second format;

FIG. 3 illustrates a data-processing device in accordance with a particularly advantageous embodiment of the invention;

FIG. 4 illustrates a graphic interface which can be used in a particularly advantageous embodiment of the invention;

FIG. 5 illustrates a telecommunication network using at least one data-processing device according to the invention.

### DESCRIPTION OF PREFERRED EMBODIMENTS

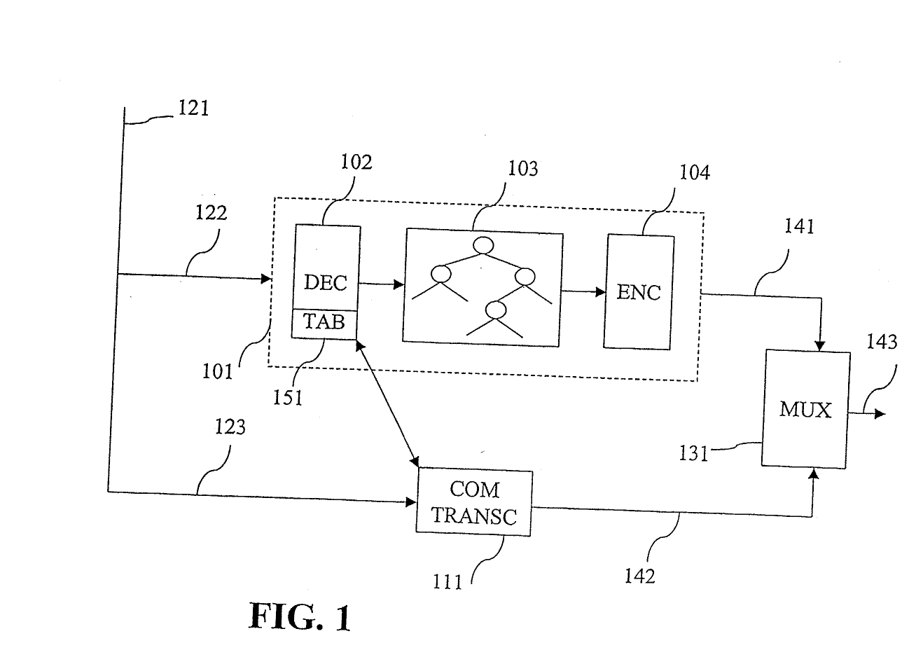

FIG. 1 illustrates characteristic features of the invention. A data-processing device according to the invention comprises a scene transcoder 101 comprising a decoder 102 and an encoder 104, a command transcoder 111 and a multiplexer 131. Data in a first format 121 contain a scene description 122 and commands 123; they are converted into data of a second format 143 by means of the data-processing device.

In the example under consideration, the first format is a BIFS text format and the second format is a BIFS binary format. The scene description in the BIFS text format 122 is decoded by the decoder 102 which constructs a scene graph 103 in the sense of the standard described above. This scene graph 103 notably comprises a tree structure having nodes. The decoder 102 allocates an identifier to each node stored in a node coding table for each node. Based on the information comprised in all the node coding tables, the decoder 102 establishes a table of correspondence 151 between the names and the identifiers of the nodes. The encoder 104 converts this scene graph 103 so as to generate a scene description in the BIFS binary format 141. The commands in the BIFS text format 123 are converted into commands in the BIFS binary format 142 by the command transcoder 111. As a command may consist of, for example, a modification of a node of the scene description 122, the command transcoder 111 has access to the table of correspondence 151 between the names and the identifiers of the nodes. This correspondence table 151 is stored, for example, in the form of a file in the decoder 102; the command transcoder 111 opens this file in order to access the required information. Indeed, the above-cited standard indicates that only the identifier of a node must be converted into the BIFS binary format. As the commands in the BIFS text format only comprise the names of the nodes to be modified, it is necessary for the command transcoder 111 to have access to the identifiers of the corresponding nodes.

The multiplexer 131 regroups the scene description in the BIFS binary format 141 and the commands in the BIFS binary format 142 for generating the data in the BIFS binary format 143. An example of the scene description in the BIFS text format 122 will be given below:

OrderedGroup {

Children [

Shape {

appearance Appearance {

material Material {emissiveColor 1 1 1}

}
geometry DEF G1 Circle {radius 20.0}

}

]

}

This scene description in the BIFS text format 122 describes a white circle (referred to as circle G1) having a radius of 20 pixels. An example of a command in the BIFS text format 123 will be given below:

AT 10000 REPLACE NODE G1 BY Rectangle {size 10 20}

This command in the BIFS text format 123 signifies that, at a certain instant, the circle G1 is replaced by a rectangle having dimensions of 10 by 20 pixels. In this example, this instant occurs 10 seconds after the start of visualizing an audiovisual representation of the scene description 122. A user can effect such a visualization on a graphic interface.

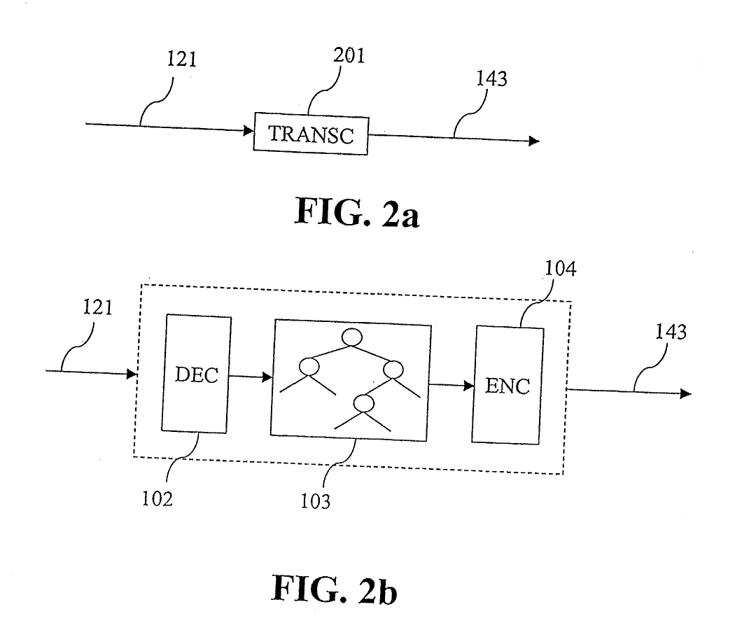

FIGS. 2a and 2b illustrate two examples of data-processing devices in accordance with the prior art, allowing a conversion of data from a first format into a second format. In FIG. 2a, the data in the first format 121 are converted into data in the second format 143 by means of a transcoder 201. The transcoder 201 converts the scene descriptions as well as the commands from the first format into the second format. Such a transcoder 201 is described in the document “ISO/IEC JTC1/SC29/WG11—title: BIFS/OD Encoder version 4.0—author: Zvi Lifshitz” published in November 1999. A drawback of such a data-processing device is that it is not user-friendly. Indeed, such a device does not allow visualization of an audiovisual representation described by the data in the first format 121. With such a device it is thus difficult for an author to modify the scene description with the aid of a mouse or a keyboard.

In FIG. 2b, the data in the first format 121 are decoded by the decoder 102 which constructs the scene graph 103. The scene graph 103 may be connected to a compositor and a graphic interface (not shown in FIG. 2b), allowing an audiovisual representation of the scene description comprised in the scene graph 103. The graphic interface may also be connected to means for modifying and means for editing commands (not shown in FIG. 2b), allowing an author to modify the audiovisual representation with the aid of, for example, a mouse or a keyboard. The scene graph 103 is then modified. This scene graph 103 is subsequently converted into the second format by the encoder 104 which generates the data in the second format 143. Such a device is described in a document published by CSELT on Dec. 20, 1999, entitled “IM-1 Two-Dimensional Compositor”. A drawback of such a data-processing device is that dynamic commands cannot be effected. Indeed, as the encoder 104 converts the scene graph 103, only the information present in this scene graph 103 during such a conversion will be taken into account. If one reverts to the preceding example of the circle G1 which is transformed into a rectangle at a certain instant, when the conversion effected by the encoder 104 precedes the instant at which the modification generated by the command 123 takes effect, it is the circle which is taken into account, and when this conversion follows this instant, it is the rectangle which is taken into account. In order that a modification of the audiovisual representation described by the data in the second format 143 effectively takes place at the instant when it must take place, it is necessary to convert the scene graph 103 immediately after this instant. This generates a larger quantity of data to be transmitted, hence a relatively low data-transmission speed.

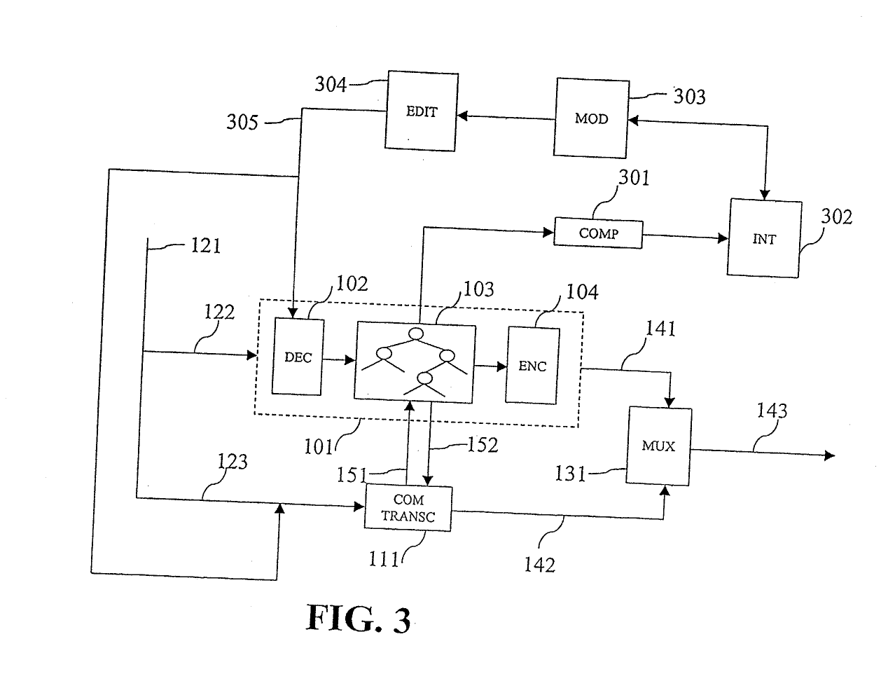

The invention mitigates these drawbacks as is shown in a particularly advantageous embodiment of the invention described with reference to FIG. 3.

FIG. 3 illustrates a data-processing device in accordance with a particularly advantageous embodiment of the invention. In addition to the elements described with reference to FIG. 1, such a data-processing device comprises a compositor 301, a graphic interface 302, modification means 303 and editing means 304 suitable for generating modification commands in the first format 305.

With the aid of the compositor 301, an audiovisual representation of the scene description comprised in the scene graph 103 can be visualized by an author on the graphic interface 302. Using the modification means 303, for example, a mouse or a keyboard, the author can modify this audiovisual representation. The editing means 304 provide the possibility of generating modification commands 305 corresponding to the modifications effected by the author. Authoring tools known to those skilled in the art have the functionalities of the compositor 301, the modification means 303 and the editing means 304. Software such as Photoshop and Adobe Premiere are examples of such authoring tools. The modification commands 305 are sent to the decoder 102 and to the command transcoder 111. With the aid of the modification commands 305, the decoder 102 updates the scene graph 103 so that the modifications which the author has effected can be visualized on the graphic interface 302. Such an update of the scene graph 103 on the basis of a command is described in the above-cited standard. This data-processing device allows, on the one hand, modification of a scene graph in a user-friendly manner without having to convert the whole scene graph when a modification is effected, because in this case only the modification command 305 must be converted from the first format into the second format. The quantity of data of the second format 143 transmitted per unit of time is therefore relatively small, which allows relatively high data-transmission speeds. On the other hand, the author may effect dynamic commands with the aid of the modification means 303. Indeed, the command transcoder 111 may take such dynamic commands into account, which is not the case with the encoder 104 which just converts the scene graph 103 into the second format.

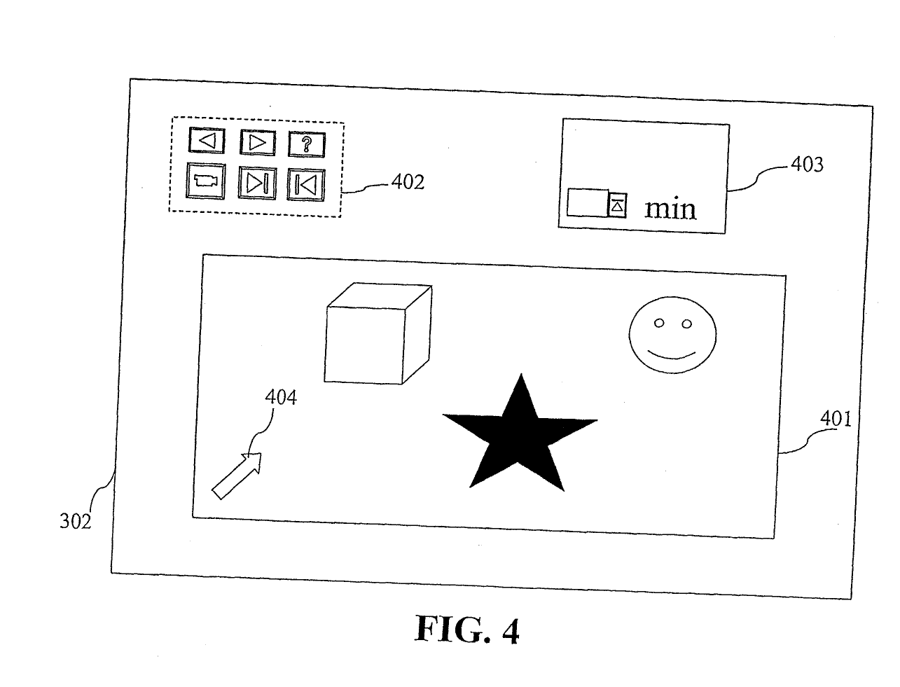

FIG. 4 illustrates an example of a graphic interface 302. The graphic interface 302 comprises a visualization zone 401, action buttons 402, a dynamic command zone 403 and a cursor 404. The visualization zone 401 enables an author to obtain an audiovisual representation of the scene graph 103. The cursor 404 commanded by the modification means 303 allows, for example, selection of an object in the visualization zone 401 so as to displace this object. Subsequent to such a modification of the audiovisual representation, the editing means 304 generate a command which is intended to modify placement parameters of the node of the scene description corresponding to this object. The action buttons 402 allow, for example, modification of a color of an object selected with the cursor 404. The dynamic command zone 403 enables the author to define at which instant a modification generated by a command must take effect. The author may define such an instant, for example, by means of a keyboard and then change dimensions of an object of the visualization zone 401. Such a change of dimensions will only take effect at the instant defined by the author.

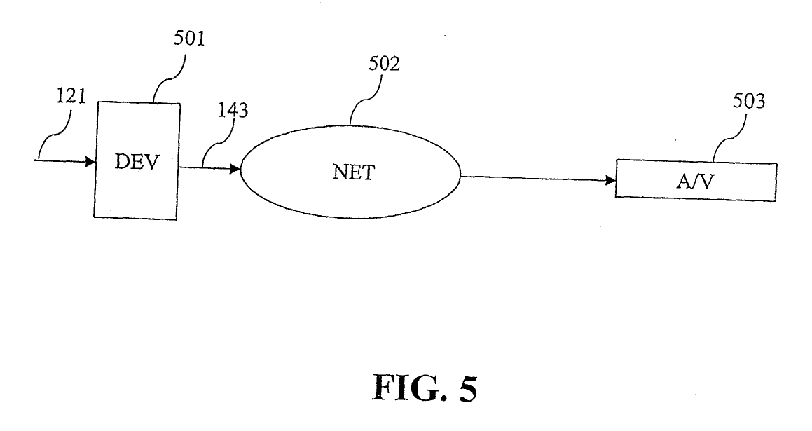

FIG. 5 illustrates an example of a telecommunication network using at least one data-processing device according to the invention. Such a telecommunication network comprises a data-processing device 501 as shown in FIG. 3, a transmission medium 502 and a reception terminal 503. The data in the first format 121 may be stored, for example, on a data carrier. As has been described in detail with reference to FIG. 3, they may be modified by an author with the aid of the data-processing device 501 which generates the data in the second format 143. These data 143 are transported by the transmission medium 502 to the reception terminal 503. The transmission medium 502 may be a transmission medium used for a telecommunication network, such as Internet, for example, Ethernet. The reception terminal 503 may comprise, for example, a central computer unit and a computer screen or a set top box and a television screen. It comprises means for visualizing the data in the second format 143, for example, a compositor. Such a reception terminal is known to those skilled in the art. Such a telecommunication network thus particularly enables an author to send audiovisual data to a user having a reception terminal 503 and to modify these data in a user-friendly manner and in real time. For example, in a scene description, one of the nodes may correspond to audiovisual information issued from a camera filming a sports event, and another node may correspond to a score. As a function of the evolution of the sports event, the author may modify the score by modifying the contents of the corresponding node. The user will thus be permanently informed of the score of the event.

The above description with reference to the Figures illustrates rather than limits the invention. In this respect, several remarks will be made below.

The description of the Figures applies to the example of the BIFS format. It should be noted that the invention is also applicable to other formats, which may be more advanced than the BIFS format in so far as these formats apply to scene descriptions and commands.

FIG. 4 only shows several functionalities of a graphic interface. Such a graphic interface may comprise a large number of functionalities, particularly functionalities corresponding to the commands defined by the format used.

In principle, it is possible to implement the method according to the invention by means of a suitably programmed integrated circuit. A set of instructions comprised in a programming memory may cause the integrated circuit to perform the different steps described hereinbefore. The set of instructions may be loaded into the programming memory by reading a data carrier such as, for example, a disc on which the set of instructions has been encoded. Reading may be effected by means of a communication network such as, for example, the Internet. In this case, a service provider puts the set of instructions at the disposal of those interested.

1. A data-processing device for converting data from a first format into a second format, said data comprising at least a scene description and a command intended to modify said scene description, characterized in that the device comprises:
a scene transcoder for converting the scene description from the first format into the second format, and
a command transcoder for converting the command from the first format into the second format and having access to information comprised in the scene transcoder.

2. A data-processing device as claimed in claim 1, characterized in that it comprises:
a graphic interface;
a compositor suitable for supplying an audiovisual representation of the scene description on the graphic interface;
modification means connected to said graphic interface and being suitable for effecting at least a modification of said audiovisual representation, and
editing means suitable for generating at least a command in the first format, said command being representative of the modification.

3. A data-processing method of converting data from a first format into a second format, said data comprising at least a scene description and a command intended to modify said scene description, characterized in that the method comprises the steps of:
transcoding the scene for converting the scene description from the first format into the second format; and
transcoding commands for converting the command from the first format into the second format by means of information elaborated during the scene transcoding step.

4. A data-processing method as claimed in claim 3, characterized in that it comprises the steps of:
composition to supply an audiovisual representation of the scene description on a graphic interface;
modification to effect at least a modification of said audiovisual representation;
editing to generate at least a command in the first format, said command being representative of the modification.

5. A telecommunication network comprising at least
a data-processing device as claimed in claim 1 or 2;
a transmission medium intended to transport said data in the second format, and
a reception terminal capable of receiving said data in the second format.

6. A program comprising program code instructions for performing the steps of the method as claimed in claim 3 or 4, when said program is executed on a processor.
